(19) United States
(12) Patent Application Publication
(10) Pub. No.: US 2022/0195892 A1
(43) Pub. Date: Jun. 23, 2022

(54) FASTENING MEANS FOR A TURBINE- OR VALVE HOUSING

(71) Applicant: Siemens Aktiengesellschaft, Munich (DE)

(72) Inventors: Johanna Marie Haan, Mulheim a. d. Ruhr (DE); Torsten-Ulf Kern, Wesel (DE)

(73) Assignee: Siemens Aktiengesellschaft, Munich (DE)

(21) Appl. No.: 17/440,346

(22) PCT Filed: Mar. 5, 2020
(86) PCT No.: PCT/EP2020/055887

§ 371 Date: Sep. 17, 2021

(30) Foreign Application Priority Data
Apr. 2, 2019 (EP) 19166719.5

(51) Int. Cl. F01D 25/24; C22C 38/54; C22C 38/52; C22C 38/48; C22C 38/46; C22C 38/44; C22C 38/06; C22C 38/02; C22C 38/04; C22C 38/00; C21D 9/00; C21D 6/00; F16B 23/00

(52) U.S. Cl. CPC F01D 25/243; F05D 2220/32; C22C 38/52; C22C 38/48; C22C 38/46; C22C 38/44; C22C 38/06; C22C 38/02; C22C 38/04; C22C 38/002; C22C 38/001; C21D 9/0068; C21D 9/0093; C21D 6/008; C21D 6/007; C21D 6/005; C21D 6/004; F16B 23/0038; F05D 2220/31; C22C 38/54

(57) ABSTRACT

A fastener for connecting a first housing part of a steam or gas turbine to a second housing part of the turbine which is made of a parent metal with a high degree of stress relaxation.

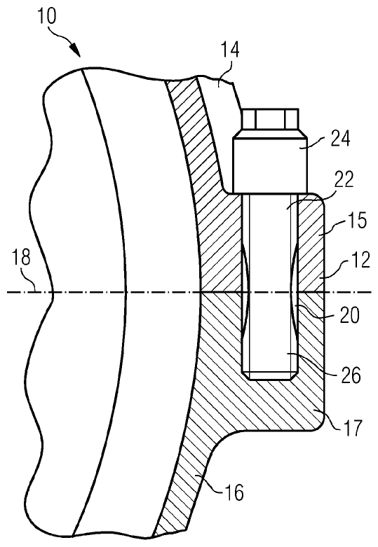

### CROSS REFERENCE TO RELATED APPLICATIONS

This application is the US National Stage of International Application No. PCT/EP2020/055887 filed 5 Mar. 2020, and claims the benefit thereof. The International Application claims the benefit of European Application No. EP19166719 filed 2 Apr. 2019. All of the applications are incorporated by reference herein in their entirety.

### FIELD OF INVENTION

The invention relates to a fastening means for connecting a first housing part of a steam or gas turbine to a second housing part of the steam or gas turbine.

The invention also relates to a turbine housing for a steam or gas turbine, having a first housing part and a second housing part and a fastening means of this type for connecting the two housing parts in a flange-like housing-joint region of the housing parts.

The invention also relates to a valve housing.

In addition, the invention relates to a turbine for a thermal power plant having a turbine housing of this type.

### BACKGROUND OF INVENTION

Turbine housing is understood here to mean the inner housing, which is generally surrounded by an outer housing, of the steam or gas turbine.

During operation of a steam turbine, it is sought to have steam states which are as high as possible. That is to say, it is sought to operate the steam turbines at steam pressures which are as high as possible and at very high steam temperatures. In this respect, bolts, as an embodiment of a fastening means, that are used to connect two housing parts of the steam turbine are exposed to high stresses and simultaneously prevailing high temperatures. In the prior art, these bolts are therefore manufactured from a highly heat-resistant material. In this respect, alloys of different compositions are used as the bolt material. The bolts used in the prior art, however, can only be used in turbine housings which are configured for relatively small pressure differences of less than 250 bar. Steam turbines configured for higher pressure differences are provided partially with special unipartite inflow housings without bolt connections. In the case of other steam turbines known in the prior art, frequent retightening and therefore opening of the turbine is necessary already after a relatively short operating time, specifically possibly already after 30 000 hours instead of 100 000 hours of operating time.

### SUMMARY OF INVENTION

An object on which the invention is based is to improve a turbine having a fastening means to the extent that the fastening means can be used even at high pressure differences, in particular at pressure differences of over 250 bar, and high temperatures of the flow medium in order to connect a first housing part to a second housing part of the turbine.

This object is achieved according to the invention by a fastening means of the generic type according to the features of the independent claim.

The object is also achieved by a turbine housing for a steam or gas turbine, which is provided with a fastening means of this type according to the invention.

In addition, the object is achieved by a turbine for a thermal power plant, having a turbine housing of this type.

The base material is formed such that the ratio of N/B (in % by weight) is between 1.0 and 5.0.

By virtue of the use of the base material according to the invention, the fastening means has a strength such that it can be used reliably at high pressure differences of over 250 bar and high temperatures in order to connect two housing parts. When the fastening means is in the form of a bolt, timely retightening of the bolt is not necessary. The material used for the bolt according to the invention as an embodiment of the fastening means has a higher initial strength, higher bolt tightness, and thus a higher relaxation final stress compared with bolt materials known in the prior art. The bolt according to the invention allows the construction of a combined turbine (combination of a high-pressure and a medium-pressure turbine cylinder in a single housing) for ultra-supercritical steam states (300 bar/600° C.). Even in the event of use in other steam turbines, such as for instance high-pressure, medium-pressure, or single-housing medium-pressure and low-pressure steam turbines, there are potentials for improvement in terms of redevelopment.

No tungsten is used in the base material according to the invention of the alloy, in order to avoid the occurrence of precipitations, e.g. of the Laves phase type, during the impingement of a component of the base material/alloy, which precipitations can grow quickly and influence the stability of the microstructure to the extent that the creep strength and the relaxation strength greatly diminish.

Additionally, with the precipitation of W-containing new phases the deformability of the base material/alloy changes, and therefore the risk of cracks at radii, notches and transitions arises and a component is at risk during operation in this way.

The setting of the N/B ratio, which is matched to the basic matrix composition, is essential for setting the long-term properties in the initial state and maintaining them over long periods of time at a high temperature. The aim is to provide sufficient N for the precipitation of V or Nb nitrides of MX and M2X type for the matrix stability, and of B for suppressing the growth of carbon-containing M23C6 precipitations when exposed to time and temperature.

Since B and N also have a high chemical affinity with one another and at unfavorable N/B ratios may produce coarse BN precipitations, N and B are in that case no longer available for the long-term strength of the microstructure. The coarse BN precipitations no longer have a strength-increasing action; the basic microstructure is considerably weakened as a result.

The fastening means may be in the form of a bolt or a stud bolt. The fastening means may also be in the form of a nut or union nut.

In one embodiment, the fastening means is in the form of a housing-joint bolt, which connects the first housing part to the second housing part in a flange-like housing-joint region. The housing-joint bolt may be configured as a threaded bolt or else as a continuous bolt.

In order to ensure the strength of the fastening means at high steam states, it is advantageous when the material of the fastening means is optimized in terms of strength in the temperature range of from 400° C. to 650° C., in particular is qualified with a strength Rp 0.2 at room temperature of at least 700 MPa. That is to say, the material of the fastening means achieves the yield strength of a plastic deformation of 0.2% only when it is subjected to a load of 700 MPa at room temperature. A bolt pretension may be taken into account as a variable in addition to the increase in the relaxation final stress.

In order in particular to achieve the material parameters mentioned above, such as for instance the strength sought for at 400° C. to 650° C., it is advantageous when the production of the fastening means comprises the following steps: melting the material constituents, subjecting the melt to a preliminary heat treatment and further processing to form a round profile, and quenching and tempering the round profile at tempering parameters of T≤720° C. During the melting, it is advantageous to use ESU steel and vigorously forge it. The quenching and tempering treatment is advantageously carried out in the form of oil quenching and tempering. A complete conversion to the martensite phase should take place over the entire outer surface of the fastening means. The quenching temperature should be between 1050° C. and 1120° C. Advantageously, a twofold tempering treatment may be carried out, it being necessary to take the following into account in that case: for the first tempering, a temperature of 570° C. is expediently used. The temperature of the second tempering treatment should be above that of the first tempering treatment.

In one expedient embodiment, the fastening means consists of the material X13CrMoCoVNbNB9-2-1. In particular, the fastening means consists up to 100% of this material. The use of this material improves the strength of the fastening means at high steam temperatures, and therefore it is optimally suited for connecting two housing parts of a corresponding steam turbine at high steam states.

A material with a composition of this type has improved properties with respect to strength, tensile strength, strain, necking and creep strength. This correspondingly improves the suitability of the fastening means manufactured from this material for the purpose of connecting two housing parts of a steam turbine subject to high steam states.

The properties, features and advantages of this invention described above, and the way in which these can be achieved, will be explained in more detail in conjunction with the invention so as to be clearer and more markedly understandable.

### BRIEF DESCRIPTION OF THE DRAWINGS

One exemplary embodiment of the invention will be described below with reference to the drawing.

### DETAILED DESCRIPTION OF INVENTION

This is intended not to illustrate the exemplary embodiment to scale, but rather the drawing, where it is conducive to clarification, is set out in a schematized and/or slightly distorted form. With regard to additions to the teaching which is directly apparent in the drawing, reference is made to the relevant prior art.

This drawing shows a sectional view of a flange-like housing-joint region of a turbine housing, having a housing-joint bolt.

The figure shows a detail of a turbine housing 12 of a steam turbine 10 in the region of a housing joint 18. Here, turbine housing 12 denotes the inner housing, which is surrounded by an outer housing, of the steam turbine 10.

The invention may also be used for a valve housing.

The turbine housing 12 has an upper, or first, housing part 14 and a lower, or second, housing part 16. The housing joint 18 is located between the first housing part 14 and the second housing part 16. The first housing part 14 and the second housing part 16 have a flange-like form in the region of the housing joint 18. A housing flange 15 of the first housing part 14 and a housing flange 17 of the second housing part 16 are provided with a bolt bore 20 having an internal thread.

The bolt bore 20 is designed to receive a housing-joint bolt 22. The housing-joint bolt 22 is an embodiment of a fastening means 22. Further embodiments of the fastening means 22 would be stud bolts or nuts, in particular union nuts. In this case, the bolt bore 20 extends completely through the housing flange 15 of the first housing part 14 and partially in the housing flange 17 of the second housing part 16. The housing-joint bolt 22 can be screwed into the bolt bore 20 from the top, i.e. from the top side of the housing flange 15 of the first housing part 14. The housing-joint bolt 22 is configured as a hexagonal bolt in the present example and has a bolt head 24 and a bolt shank 26 with an external thread which is adapted to the internal thread of the bolt bore 20. In the position, shown in the figure, of the housing-joint bolt 22 in which it has been completely screwed into the bolt bore 20, said housing-joint bolt constitutes a fixed connection between the first housing part 14 and the second housing part 16 via the respective housing flanges 15 and 17. The housing-joint bolt 22 may also be designed in various other forms of configuration in addition to the form of configuration shown in the figure. For example, the housing-joint bolt 22 may also be in the form of a threaded bolt with corresponding bolt nuts on its respective end faces.

The housing-joint bolt 22 is formed from a base material.

The chemical composition of the base material of the housing-joint bolt 22 is composed of the following chemical elements:

C: 0.10 to 0.17% by weight,

Mn: 0.20 to 0.60% by weight,

Cr: 8.0 to 11.0% by weight,

Mo: 1.0 to 2.0% by weight,

Co: 0.50 to 2.00% by weight,

N: 0.010 to 0.050% by weight,

B: 0.005 to 0.015% by weight,

V: 0.10 to 0.30% by weight,

Al: at most 0.010% by weight,

Nb: 0.02 to 0.08% by weight,

Ni: 0.10 to 0.50% by weight,

Si: at most 0.10% by weight,

P: at most 0.010% by weight,

S: at most 0.005% by weight,

Fe: remainder.

The base material is formed in such a way that the ratio of N/B (in % by weight) is between 1.0 and 5.0.

The bolt (22) consists of the material X13CrMoCoVNbNB9-2-1, in particular the bolt consists up to 100% of this material.

The base material of the bolt (22) is optimized in terms of strength in the temperature range of from 400° C. to 650° C., in particular is qualified with a strength Rp 0.2 of at least 700 MPa at room temperature.

The production of the bolt (22) comprises the following steps: melting the material constituents, subjecting the melt to a preliminary heat treatment and further processing to form a round profile, and quenching and tempering the round profile at tempering parameters of T<720° C.

C=carbon, Mn=manganese, Cr=chromium, Mo=molybdenum, Co=cobalt, N=nitrogen, B=boron, V=vanadium, Al=aluminum, Nb=niobium, Ni=nickel, Si=silicon, P=phosphorus, S=sulfur, Fe=iron, W=tungsten.

1. A fastening means for connecting a first housing part of a steam or gas turbine to a second housing part of the steam or gas turbine, wherein the fastening means is formed from a base material, wherein the base material comprises the following composition:
C: 0.10 to 0.17% by weight,
Mn: 0.20 to 0.60% by weight,
Cr: 8.0 to 11.0% by weight,
Mo: 1.0 to 2.0% by weight,
Co: 0.50 to 2.00% by weight,
N: 0.010 to 0.050% by weight,
B: 0.005 to 0.015% by weight,
V: 0.10 to 0.30% by weight,
Al: at most 0.010% by weight,
Nb: 0.02 to 0.08% by weight,
Ni: 0.10 to 0.50% by weight,
Si: at most 0.10% by weight,
P: at most 0.010% by weight,
S: at most 0.005% by weight,
Fe: remainder,
wherein the base material is formed such that a ratio of N/B (in % by weight) is between 1.0 and 5.0.

2. The fastening means as claimed in claim 1,
wherein the base material comprises 0.5 to 1.5% by weight of Co and at most 5% by weight of W.

3. The fastening means as claimed in claim 1,
wherein the fastening means comprises a bolt.

4. The fastening means as claimed in claim 1,
wherein the fastening means comprises a union nut for connecting two components.

5. The fastening means as claimed in claim 1,
wherein the fastening means comprises a housing-joint bolt which connects the first housing part to the second housing part in a flange-like housing-joint region.

6. The fastening means as claimed in claim 1,
wherein the base material is optimized in terms of strength in a temperature range of from 400° C. to 650° C.

7. The fastening means as claimed in claim 1,
wherein production of the fastening means comprises:
melting material constituents,
subjecting the melt to a preliminary heat treatment and further processing to form a round profile, and
quenching and tempering the round profile at tempering parameters of T<720° C.

8. The fastening means as claimed in claim 1,
wherein the fastening means consists of the material X13CrMoCoVNbNB9-2-1.

9. A turbine housing for a steam or gas turbine, comprising:
a first housing part,
a second housing part,
a fastening means as claimed in claim 1 for connecting the first and second housing parts in a flange-like housing-joint region of the housing parts.

10. A valve housing for a steam or gas turbine, comprising:
a valve housing top part,
a valve housing bottom part, and
a fastening means as claimed in claim 1 for connecting the valve housing top part to the valve housing bottom part.

11. A turbine for a thermal power plant, comprising:
a turbine housing as claimed in claim 9.

12. A turbine for a thermal power plant, comprising:
a valve housing as claimed in claim 10.

13. A turbine for a thermal power plant, comprising:
a turbine housing,
a valve housing, and
a fastening means as claimed in claim 1;
wherein the turbine housing comprises a first housing part, a second housing part, and the fastening means for connecting the first and second housing parts in a flange-like housing-joint region of the housing parts; and
wherein the valve housing comprises a valve housing top part, a valve housing bottom part, and the fastening means for connecting the valve housing top part to the valve housing bottom part.

14. The fastening means as claimed in claim 6,
wherein the base material is qualified with a strength Rp 0.2 of at least 700 MPa at room temperature.

15. The fastening means as claimed in claim 8,
wherein the fastening means consists of the material X13CrMoCoVNbNB9-2-1 up to 100% thereof.
